(19) United States
(12) Patent Application Publication
(10) Pub. No.: US 2007/0102175 A1
(43) Pub. Date: May 10, 2007

(54) Surgical apparatus capable of converting rotary motion to rectilinear motion

(76) Inventors: Jose M. Lamanna, Jupiter, FL (US); Thomas D. Anspach, Jupiter, FL (US)

Correspondence Address: NORMAN FRIEDLAND, 2855 PGA BOULEVARD, SUITE 200, PALM BEACH GARDENS, FL, 33410, US

(21) Appl. No.: 11/269,349

(22) Filed: Nov. 8, 2005

(51) Int. Cl. B25D 9/00

(52) U.S. Cl. 173/114

(57) ABSTRACT

Rotary motion is converted into linear motion for a surgical instrument, such as a saw, by mechanically connecting the eccentric shaft portion of an off set shaft driven by the rotary motor to a drum having a collet interconnected by a yoke. The eccentric shaft portion of the off set shaft includes a bearing and spherical ring disposed between the eccentric shaft portion and the bifurcated arms of the yoke and through a radially extending projection fitted into a hole in the drum drives the drum in a rectilinear motion. The offset shaft portion, the eccentric shaft portion and drum are parallelly disposed relative to each other and enhances the life and provides a substantially quieter and vibration free surgical instrument

### RELATED APPLICATIONS

Not applicable

### FEDERALLY SPONSORED RESEARCH OR DEVELOPMENT

Not applicable

### TECHNICAL FIELD

This invention relates to a surgical motor used for sawing and the like and includes mechanism for converting rotary motion to linear motion. In particular, this invention is characterized as utilizing a drive shaft and eccentric shaft that are parallel to the driven shaft.

### BACKGROUND OF THE INVENTION

There are a sundry of motor mechanisms in the medical field as well as the construction field that are designed to convert rotary motion to linear or rectilinear motion necessary to operate a motorized saw. The mechanism for making the conversion in both the medical and non-medical field typically use a wobble plate or an angularly mounted drive shaft that converts the rotary motion of the motor to the linear motion necessary to power the saw blade. While such mechanism are generally efficient, they have the propensity of wearing prematurely and inducing a great deal of vibratory motion. Obviously, the reciprocating electric saw used for non-medical purposes need not concern itself over the vibratory motion, size and feel of the mechanism. On the other hand these conditions and characteristics of the non-medical saws are far different than the parameters necessary for the power saws utilized by surgeons. In accordance with this invention, we have provided conversion mechanism that is characterized as providing less vibrations and noise hereto known in both the prior art medical power saws and commercial power saws. We have found that by virtue of this invention the power saw enhances the feel of the motor in the hands of a surgeon, is small and light weight and has an increased life. It is quite apparent that a motor that generates less noise and vibration provides an improved feel in the hands of a surgeon who typically is performing intricate work during the surgical procedure performed on a patient. Of course, in the interest of economy it is abundantly important to increase the useable life of the motor.

U.S. Pat. No. 5,555,626 granted to Fuchs on Sep. 17, 1996 entitled RECIPROCATING DRIVE MECHANISM exemplifies a motion conversion motor that utilizes a wobble plate which as is typical in these designs uses an angularly or oblique angle mechanism disposed shaft between the driving and driven members. Such devices are capable of being hand held and are portable.

Saws for medical purposes are exemplified in U.S. Pat. Nos. 4,827,615, 5,916,218, 5,606,603, and 6,302,406 granted to Graham on May 9, 1989, entitled MICROSURGERY SAW DRIVE, granted to Hagen et al on Jun. 29, 1999 entitled SAW FOR SURGICAL PURPOSES, granted to Linden on Mar. 11, 1997 entitled SURGICAL CUTTING DEVICE WITH SAFETY INTERLOCK, granted to Ventura on Oct. 16, 2001 entitled CONNECTOR ASSEMBLY FOR A SURGICAL SAW BLADE. As in the teachings of these patents and the non-medical patents the mechanism for converting the rotary motion developed by the motor is obtain by mechanism that includes a member that is angularly disposed relative to the driving and or driven mechanism. We have found that the problem with the converting mechanism is that it adversely affects the life of the medical saw. Moreover, typically these heretofore known devices are prone to have vibrations in the handle and produce unwanted noise.

We have found that we can obviate the problems alluded to in the above paragraph by disposing the driving, driven and conversion mechanism parallel to each other. Not only has this arrangement shown to enhance the longevity of the instrument, it also provides an improved “feel” to the surgeon as it eliminates or reduces vibrations and eliminates or at least lowers the noise level.

### SUMMARY OF THE INVENTION

An object of this invention is to provide an improved saw for use in medical procedures.

Another object of this invention is to provide mechanism that converts rotary motion to linear motion with the use of parallel shafts for a saw or other medical instrument and is characterized as reducing noise levels, reducing vibrations, is lighter in weight and increasing the useful life of the saw.

The foregoing and other features of the present invention will become more apparent from the following description and accompanying drawings.

### BRIEF DESCRIPTION OF THE DRAWINGS

FIG. 1 is a perspective view of the medical attachment mechanism for converting rotary motion into linear or oscillating motion to provide rectilinear motion imparted to a saw or other surgical instrument;

FIG. 2 is an exploded view of the conversion mechanism of this invention and details the parts of the mechanism depicted in FIG. 1; and

FIG. 3 is a sectional view of the assembled mechanism of the apparatus depicted in FIGS. 1 and 2.

### DETAILED DESCRIPTION OF THE INVENTION

This invention details, in the preferred embodiment, mechanism for converting rotary motion to linear motion for driving a saw used in medical procedures. While in the preferred embodiment the mechanism powers the saw in a rectilinear motion, as one skill in this art will appreciate, the actuating mechanism can be designed by relocating the cam and with minor changes to the structure to produce an oscillating motion for medical instruments where an up and down motion, rather than in and out motion is desired.

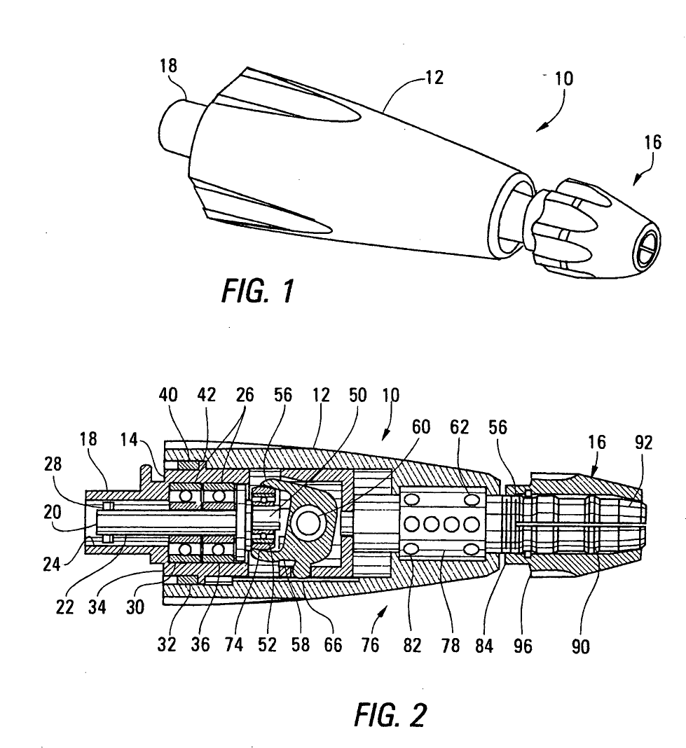

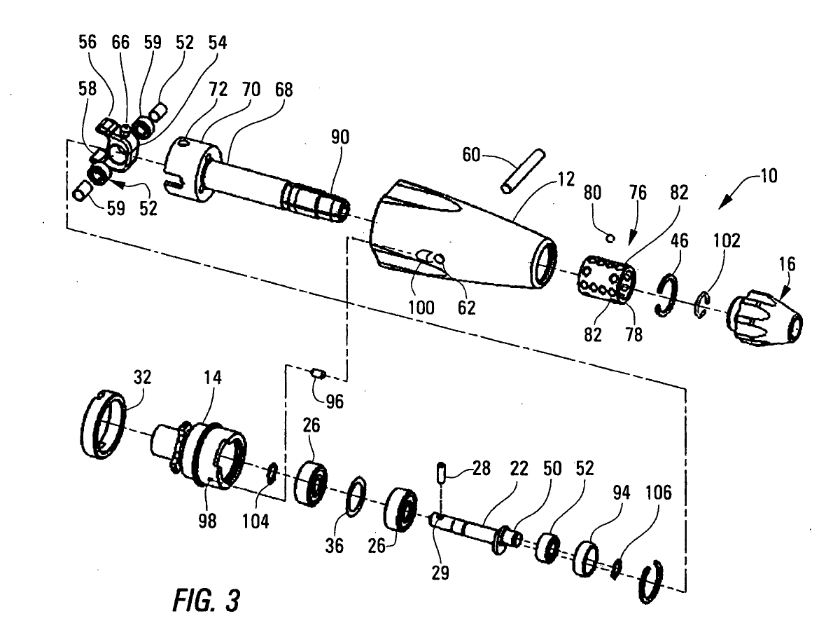

As best seen in FIGS. 1, 2 and 3 the medical apparatus for converting rotary motion to linear motion is generally illustrated by reference numeral 10 having a main body 12 that serves as a handle for the surgeon, a lock adapter 14 for attaching to a motor (not shown) for producing rotary motion and collet mechanism generally illustrated by reference numeral 16 for attaching a surgical instrument, say a saw blade (not shown). As noted in FIG. 3 the reduced diameter portion 18 of lock adapter extending outwardly at the aft end of the main body 12 removably fits into the motor securing chuck (not shown) at the aft end 20 of the offset shaft 22 disposed in the reduced diameter bore section 24 of the central through bore 26 of the lock adapter 14. A dowel pin 28 extending through a hole (29) in the end of shaft 22 serves to connect to the motor drive (not shown) by inserting a slotted portion of the drive mechanism to engage the dowel pin 28. It will be noted that the length of dowel pin 28 is less than the diameter of the bore 24 so that the edges of dowel pin 28 are spaced from the wall of bore 24. The chuck portion of the motor which are commercially available and are well known are omitted here from for the sake of simplicity and convenience. A pair of commercially available ball bearings 26 separated by the wave washer 36 are disposed in the larger diameter bore portion 30 of the lock adapter 14 for supporting the offset shaft 22 for rotary motion.

The lock adapter 14 is secured to the main body or casing 12 by the threaded bushing 32 that threaded to the inner surface enlarged bore 34 formed in the casing 12. The lock adapter carries flange 40 that extends outwardly toward the inner diameter of the enlarged bore portion 42 formed on the aft end of the casing 12. This flange is forced against the shoulder 42 and bears there against and is locked into position by the threaded bushing 32.

The stub shaft portion 50 is formed on fore end of the offset shaft 22 and is oriented eccentrically relative but parallel thereto. Bearing 52 is snugly fitted to the end of stub shaft 50 which in turn is mounted in the yoke 54 between the bifurcated arms 56 and 58. Yoke 54 is rotatably mounted to casing 12 by pin 60 that fits through the opposed drilled holes 62 formed in the casing 12 and is rotary supported by a pair of bearings 52 made from a ceramic material and includes roller or bushing 59 mounted therein. The yoke 54 carries a laterally extending projection 66 that serves as a cam as will be explained in detail herein below. Mechanically connected to the yoke 54 is the drum 68 that carries enlarged hollow portion 70 formed on the end thereof and may be formed integrally therewith or mechanically coupled thereto. Aperture 72 formed on the end of the enlarged portion 70 serves to receive the projection 66 and the dynamics of the system serves to convert the rotary motion of the offset shaft 22 to a linear motion of the drum 68 by virtue of the action between the rotary motion of bearing 52, yoke 54, projection 66 and drum 68. To assure a smooth transition from the rotary motion to the linear motion, the spherical ring 74 is fitted between the bearing 52 and arms 56 and 58 of yoke 54.

Drum 68 is supported to casing 12 by the linear bearing 76 which consists of a cylindrical cage 78 and a plurality of balls 80 fitted into predetermined holes 82. Obviously, the drum rides on the inner surface of the balls so as to effectually provide a smooth and efficient rectilinear motion. The collet 16 is threadably fitted on the end of drum 68 by virtue of the threads 84 formed on the drum 68 and the inner threads 86 formed on the aft end of collet nut 88. The fore end of drum 86 includes the axial slot 90 that serves to receive the removably mounted saw blade (not shown). The inner surface 92 of the collet nut 88 is conically shaped so that as the nut is threaded on the drum 84 in an aft direction, the end of the collet nut 88 drives the gap in the slot 90 toward a closed position, urging the surfaces of the slot 90 against the saw blade for securing the same to the drum for rectilinear movement. Snap ring 94 serves to prevent the collet nut 88 from inadvertently become dislodged by overturning the collet nut.

Pin 96 serves to orient the lock adapter 14 to casing 12 and fits into hole 98 in lock adapter 14 and the slot 100 formed on the inner surface of the casing 12. Retaining ring 102 serves to hold the linear bearing 76 securely in place in the casing 12 as does the snap rings 104 and 106 that support the offset shaft 22 in place.

In operation the rotary motion imparted to the offset shaft 22 is converted to linear motion of the drum 86 by virtue of the dynamics of the eccentric stub shaft driving the bearings and spherical ring against the arms 56 and 58 of the yoke 54 rotating the same about the pin 60.

The projection 66 of yoke 54 defines a cam that drives the drum 68 that defines the follower.

The back and forth motion of the cam essentially defines the linear motion that is ultimately carried to the collet 16. It will be appreciated that the offset shaft 22, the stub shaft 50, and drum 68 are all parallel to each other. It has been found that this arrangement not only effectively produces a surgical saw that has improved the operating life of those heretofore known surgical saws, but also operates with virtually no vibratory motion and noiseless which provides a better feel in the hands of the surgeon.

Although this invention has been shown and described with respect to detailed embodiments thereof, it will be appreciated and understood by those skilled in the art that various changes in form and detail thereof may be made without departing from the spirit and scope of the disclosed invention.

It is claimed:

1. A surgical instrument having a drum movable in a rectilinearly being driven by a rotating shaft, a stub shaft portion eccentrically disposed on the end of said rotating shaft and being parallel thereto, a drum being axially and parallel to said stub shaft and mechanically connected thereto, a yoke pivotally mounted adjacent to the end of said drum, a bearing mounted on said stub shaft and operatively connected to said yoke for rotating said yoke, a radially extending projection on said yoke fitted into a hole in said drum for driving said drum in a rectilinear motion, said drum, said stub shaft and said rotating shaft being disposed parallel to each other and means for rotating said rotating shaft.

2. A surgical instrument as claimed in claim 1 wherein said drum includes bifurcated arms, said bearing mounted between said bifurcated arms.

3. A surgical instrument as claimed in claim 2 including a spherical shaped ring disposed between said bearing and said bifurcated arms.

4. A surgical instrument as claimed in claim 1 including a collet carried by said drum and a collet nut for opening and closing said collet whereby said collet removably supports a medical tool for use in a medical procedure.

5. A surgical instrument as claimed in claim 4 including a linear bearing supporting said drum.

6. A surgical instrument as claimed in claim 5 wherein said linear bearing includes a cylindrical cage and a plurality of balls mounted in discrete holes formed in said cage.

7. A surgical instrument as claimed in claim 6 including a lock adapter disposed adjacent to one end said rotating shaft interconnecting said rotating shaft and said means for rotating said shaft.

8. Apparatus for converting rotary motion to linear motion comprising a casing, a rotating shaft rotary supported in said casing, a lock adapter mounted on the aft end of said casing and disposed adjacent to the aft end os said rotary shaft for removably accepting a rotating power source for imparting rotary motion to said rotary shaft, a stub shaft portion on the fore end of said rotary shaft, a bearing mounted on said rotary shaft, a yoke disposed adjacent the fore end of said rotary shaft and pivotally supported to said casing and operatively connected to said bearing for imparting rotary motion thereto, a drum, a linear bearing supporting said drum to said casing, a radially extending portion on said yoke operatively connected to said drum for imparting linear motion thereto and said rotary shaft, said stub shaft portion and said drum being mounted in parallel relationship to each other.

9. Apparatus for converting rotary motion to linear motion as claimed in claim 9 wherein said yoke includes a pair of bifurcated arms, and a spherical ring mounted between said bearing and said spherical arms.

10. Apparatus for converting rotary motion to linear motion as claimed in claim wherein said linear bearing includes a cylindrical cage and a plurality of balls mounted in discrete holes formed in said cage.

11. Apparatus for converting rotary motion to linear motion as claimed in claim 10 including a pair of ball bearings supporting said rotary shaft wherein a portion of said ball bearings is disposed in said lock adapter and a portion of said ball bearings is disposed in said casing.

12. Apparatus for converting rotary motion to linear motion as claimed in claim 11 including a wave washer, said wave washer surrounding said rotary shaft and disposed between said pari of ball bearings.

13. Apparatus for converting rotary motion to linear motion as claimed in claim 12 including a pin fitted into a slot formed in said lock adapter and a slot formed in said casing to orient the position of said lock adapter to said casing.

14. A surgical instrument comprising a casing, a rotating shaft rotary supported in said casing, a lock adapter mounted on the aft end of said casing and disposed adjacent to the aft end of said rotary shaft for removably accepting a rotating power source for imparting rotary motion to said rotary shaft, a stub shaft portion on the fore end of said rotary shaft, a bearing mounted on said rotary shaft, a yoke disposed adjacent the fore end of said rotary shaft and pivotally supported to said casing and operatively connected to said bearing for imparting rotary motion thereto, a drum, a linear bearing supporting said drum to said casing, a radially extending portion on said yoke operatively connected to said drum for imparting linear motion thereto, a collet formed on one end of said drum adapted to removably receive a surgical tool, a collet nut operatively connected to said collet for locking said surgical tool in place, and said rotary shaft, said stub shaft portion and said drum being mounted in parallel relationship to each other whereby the rectilinear motion of said drum is substantially noiseless and vibration free.

15. A surgical instrument as claimed in claim 14 wherein said yoke includes a pair of bifurcated arms, and a spherical ring mounted between said bearing and said spherical arms.

16. A surgical instrument as claimed in claim 15 wherein said linear bearing includes a cylindrical cage and a plurality of balls mounted in discrete holes formed in said cage.

17. A surgical instrument as claimed in claim 16 including a pair of ball bearings supporting said rotary shaft wherein a portion of said ball bearings is disposed in said lock adapter and a portion of said ball bearings is disposed in said casing.

18. A surgical instrument as claimed in claim 17 including a wave washer, said wave washer surrounding said rotary shaft and disposed between said pair of ball bearings.

19. A surgical instrument as claimed in claim 18 including a pin fitted into a slot formed in said lock adapter and a slot formed in said casing to orient the position of said lock adapter to said casing.

20. A surgical instrument wherein said bearing is made from the outer cage is made from a ceramic material and a cylindrical bushing mounted in said outer cage.
